(19) United States
(12) Patent Application Publication
(10) Pub. No.: US 2012/0071190 A1
(43) Pub. Date: Mar. 22, 2012

(54) BASE STATIONS AND RADIO DEVICES

(75) Inventors: Hyung-Nam Choi, Hamburg (DE); Maik Bienas, Braunschweig (DE)

(73) Assignee: INFINEON TECHNOLOGIES AG, Neubiberg (DE)

(21) Appl. No.: 12/886,606

(22) Filed: Sep. 21, 2010

(51) Int. Cl. H04B 7/00

(52) U.S. Cl. 455/517

(57) ABSTRACT

According to an embodiment, a base station operates a first radio cell of a mobile communication network and signals, for a mobile terminal in the first radio cell having a communication connection via the base station, to a first radio device of a plurality of radio devices located in the first radio cell, wherein each radio device operates a second radio cell, that the first radio device is to provide a communication connection for the mobile terminal. Further, the base station signals, for the mobile terminal, to at least one second radio device of the plurality of radio devices, that the at least one second radio device is to take into account the allocation of radio resources by the first radio device for the communication connection to be provided for the mobile terminal when allocating radio resources for communication within the second radio cell operated by the at least one second radio device.

### TECHNICAL FIELD

Embodiments generally relate to base stations and radio devices.

### BACKGROUND

In a heterogeneous communication network, low power nodes such as home base stations or relay nodes may be located in a macro radio cell operated by a macro base station. Since low power nodes may share radio resources with each other and with the macro radio cell base station, inter-cell interference may become an issue in such heterogeneous networks. Accordingly, efficient methods for interference mitigation in heterogeneous networks are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a communication system according to an embodiment.

FIG. 2 shows a frame in accordance with an embodiment.

FIG. 3 shows an OFDMA symbol allocation according to one embodiment.

FIG. 4 shows a state transition diagram according to an embodiment.

FIG. 5 shows a communication arrangement according to an embodiment.

FIG. 6 shows a communication arrangement according to an embodiment.

FIG. 7 shows a base station according to an embodiment.

FIG. 8 shows a flow diagram according to an embodiment.

FIG. 9 shows a radio device according to an embodiment.

FIG. 10 shows a flow diagram according to an embodiment.

FIG. 11 shows a radio device according to an embodiment.

FIG. 12 shows a flow diagram according to an embodiment.

FIG. 13 shows a base station according to an embodiment.

FIG. 14 shows a flow diagram according to an embodiment.

FIG. 15 shows a radio device according to an embodiment.

FIG. 16 shows a flow diagram according to an embodiment.

FIG. 17 shows a communication system according to an embodiment.

FIG. 18 shows a message flow diagram according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

3GPP (3rd Generation Partnership Project) has introduced LTE (Long Term Evolution) into the Release 8 version of UMTS (Universal Mobile Telecommunications System) standards. With LTE the UMTS air interface is further optimized for packet data transmission by improving the system capacity and the spectral efficiency. Amongst others, the maximum net transmission rate is increased significantly, namely to 300 Mbps in the downlink transmission direction and to 75 Mbps in the uplink transmission direction. Further, LTE supports scalable bandwidths of 1.4, 3, 5, 10, 15, and 20 MHz and is based on the multiple access methods OFDMA/TDMA (orthogonal frequency division multiple access/time division multiple access) in downlink and SC-FDMA/TDMA (single carrier-frequency division multiple access/TDMA) in uplink. OFDMA/TDMA is a multicarrier multiple access method in which a subscriber is provided with a defined number of subcarriers in the frequency spectrum and a defined transmission time for the purpose of data transmission. The RF bandwidth capability of an LTE UE (user equipment) for transmission and reception has been set to 20 MHz. A physical resource block (PRB) is the baseline unit of allocation for the physical channels defined in LTE. A physical resource block includes a matrix of 12 subcarriers by 6 or 7 OFDMA/SC-FDMA symbols. A pair of one OFDMA/SC-FDMA symbol and one subcarrier is denoted as resource element.

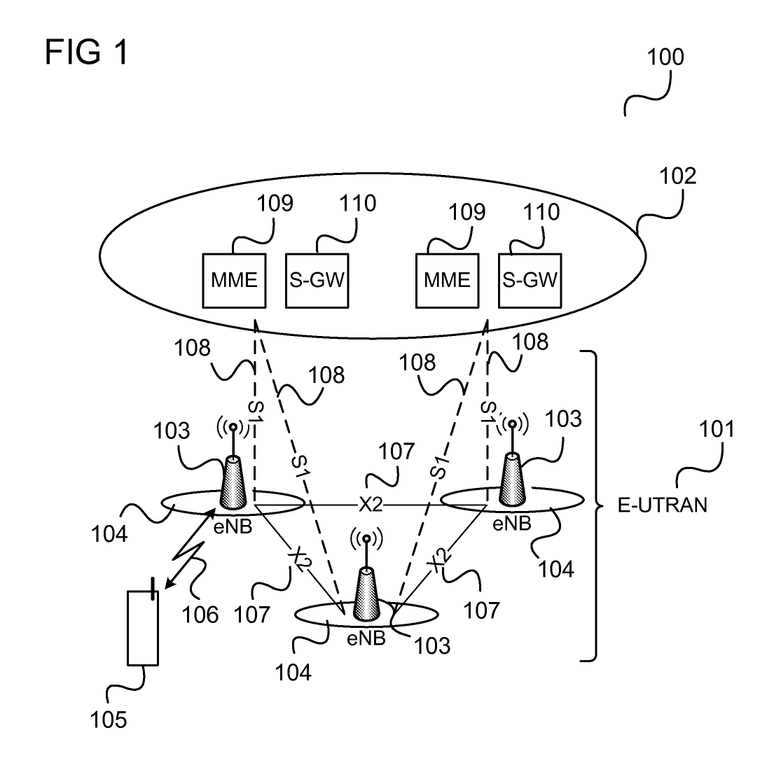

FIG. 1 shows a communication system 100 according to an embodiment.

According to this embodiment, the communication system 100 is configured in accordance with the network architecture of LTE. The communication system 100 may also be configured according to other communication standards in other embodiments, e.g. according to UMTS (Universal Mobile Telecommunications System).

The communication system 100 includes a radio access network (E-UTRAN, Evolved UMTS Terrestrial Radio Access Network) 101 and a core network (EPC, Evolved Packet Core) 102. The E-UTRAN 101 may include base (transceiver) stations (eNodeBs, eNBs) 103. Each base station 103 provides radio coverage for one or more mobile radio cells 104 of the E-UTRAN 101.

A mobile terminal (UE, user equipment) 105 located in a mobile radio cell 104 may communicate with the core network 102 and with other mobile terminals 105 via the base station providing coverage (in other words operating) in the mobile radio cell.

Control and user data are transmitted between a base station 103 and a mobile terminal located in the mobile radio cell 104 operated by the base station 103 over the air interface 106 on the basis of a multiple access method.

The base stations 103 are interconnected with each other by means of the X2 interface 107. The base stations are also connected by means of the S1 interface 108 to the core network (Evolved Packet Core) 102, more specifically to an MME (Mobility Management Entity) 109 and a Serving Gateway (S-GW) 110. The MME 109 is responsible for controlling the mobility of UEs located in the coverage area of E-UTRAN, while the S-GW 110 is responsible for handling the transmission of user data between mobile terminals 105 and core network 102.

In one embodiment, according to LTE, the communication system 100 supports the following types of duplexing methods: full-duplex FDD (frequency division duplexing), half-duplex FDD and TDD (time division duplexing). According to full-duplex FDD two separate frequency bands are used for uplink transmission (i.e. transmission from mobile terminal 105 to base station 103) and downlink transmission (i.e. transmission from base station 103 to mobile terminal 105) and both transmissions can occur simultaneously. According to half-duplex FDD also two separate frequency bands are used for uplink and downlink transmissions, but both transmissions are non-overlapping in time. According to TDD the same frequency band is used for transmission in both uplink and downlink. Within a time frame the direction of transmission may be switched alternatively between downlink and uplink.

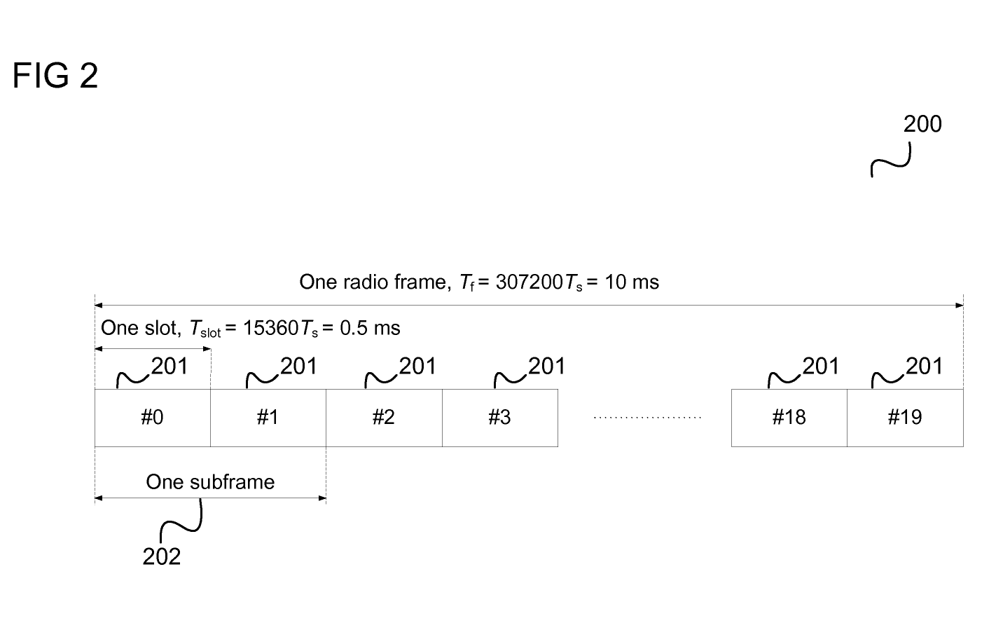

Data transmission between the mobile terminal 105 and the corresponding base station 103 (i.e. the base station operating the radio cell in which the mobile terminal 105 is located) is carried out in accordance with a (radio) frame structure. An example for a frame structure, denoted as frame structure type 1, is shown in FIG. 2.

FIG. 2 shows a frame 200 in accordance with an embodiment.

The frame 200 may be used for both full-duplex and half-duplex FDD. The frame 200 is 10 ms long and consists of 20 slots 201 of length 0.5 ms, numbered from 0 to 19. A subframe 202 is defined as two consecutive slots 201. In each 10 ms interval 10 subframes 202 are available for downlink transmissions or uplink transmissions. Uplink and downlink transmissions are separated in the frequency domain. Depending on the slot format a subframe 202 may include 14 or 12 OFDMA (orthogonal frequency division multiple access) symbols in DL (downlink) and 14 or 12 SC-FDMA symbols in UL (uplink), respectively.

In DL a subframe of length 1 ms is separated into a control channel region occupying a definite number of OFDMA symbols (up to 4 OFDMA symbols), and a PDSCH region occupying the remaining OFDMA symbols. The length of the control channel region and PDSCH region is configured by the network.

According to one embodiment, according to LTE UL/DL and FDD mode, the following physical channels are specified:

PUSCH:
Uplink physical channel.
Carries user and control data in uplink.

PUCCH:
Uplink physical channel only, i.e. no logical and transport channels are mapped to this channel.
Carries the control information such as HARQ (Hybrid automatic repeat request) ACK/NACKs (acknowledgements/negative acknowledgements) in response to downlink transmissions on PDSCH, scheduling requests and CQI (channel quality indication) reports.

PDSCH:
Downlink physical channel.
Carries user and control data and paging messages and system information.
Is transmitted in the PDSCH region of a subframe, i.e. occupies the OFDMA symbols in a subframe not occupied by PDCCH.

PDCCH:
Downlink physical channel only, i.e. no logical and transport channels are mapped to this channel.
Carries the control information related to DL/UL transmissions such as resource assignments and HARQ information.
Occupies 1, 2, 3 or 4 OFDMA symbols in the first slot in a subframe. The number of symbols is adjusted by network and signaled on PCFICH.

PCFICH:
Downlink physical channel.
Informs the UE about the number of OFDMA symbols used for the PDCCHs.
Occupies the first OFDMA symbol in the first slot in a subframe.
Is transmitted when the number of OFDMA symbols for PDCCH is greater than zero.

P-BCH:
Downlink physical channel.
Carries Hybrid ARQ ACK/NACKs in response to uplink transmissions on PUSCH.
Occupies 1, 2, or 3 OFDMA symbols in the first slot in a subframe. The number of symbols is adjusted by network and signaled on P-BCH.

P-BCH:
Downlink physical channel.
Carries system information to be broadcast in the cell such as DL bandwidth information and number of OFDMA symbols assigned to PHICH.

With respect to cell search, i.e. synchronization to a radio cell 104 and identification of a radio cell 104, the following physical signals and physical channel may for example be used:
The PSS (Primary Synchronization Signal) and SSS (Secondary Synchronization Signal) are used to acquire slot and frame timing of a radio cell 104 and to determine the physical layer cell identity of the radio cell 104. The PSS and SSS are mapped in frequency-domain to 62 subcarriers around the DC (Direct Current) subcarrier and in time-domain to the last/second last OFDMA symbol in slots #0 and #10 in each radio frame. In LTE overall 504 physical layer cell identities may be defined, and each radio cell may be allocated with one physical layer cell identity only. The physical layer cell identity is used for cell-specific scrambling of PDSCH, PBCH, PCFICH, PDCCH, PHICH, PUSCH, PUCCH, and for cell-specific frequency shift of reference signals.
The PBCH (Physical Broadcast Channel) is used to signal cell-specific physical layer information such as downlink bandwidth size and system frame number (SFN). The PBCH is mapped in frequency-domain to 72 subcarriers around the DC subcarrier, and in time-domain to the first four OFDMA symbols in slot #1 in each radio frame.

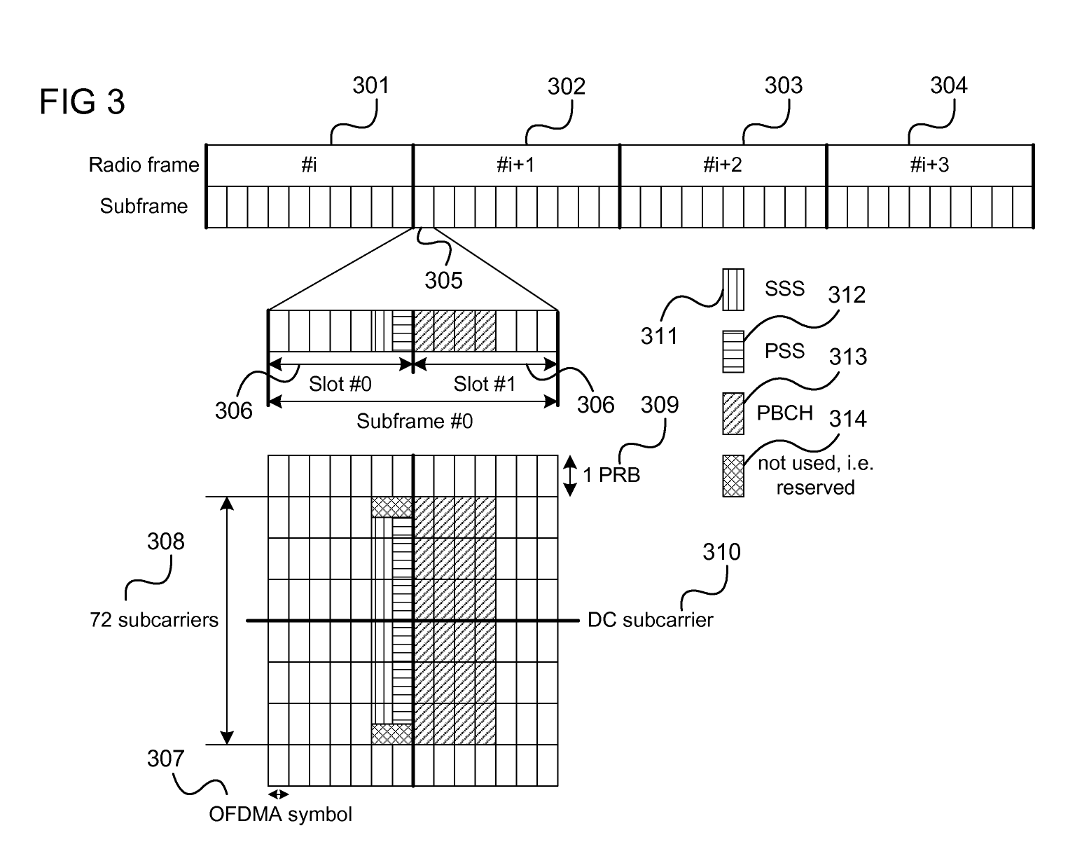

The time and frequency position of the resources for transmitting the PSS, the SSS and the PBCH is illustrated in FIG. 3.

FIG. 3 shows an OFDMA symbol allocation according to one embodiment.

Four radio frames 301, 302, 303, 304 are shown in FIG. 3, each having the structure as explained above with reference to FIG. 2, i.e. each including 10 subframes 305 wherein each subframe 305 includes two slots 306.

In this embodiment, each slot may include 7 OFDMA symbols 307 for each of 72 sub-carriers 308. A physical resource block 309 includes a matrix of 12 subcarriers by 7 OFDMA symbols 307.

The DC subcarrier 310 is the subcarrier around the carrier frequency.

A first hatching 311 indicates the radio resources used for the SSS in subframe #0, a second hatching 312 indicates the radio resources used for the PSS in subframe #0, and a third hatching 313 indicates the radio resources used for the PBCH in subframe #0. A fourth hatching 314 indicates unused, e.g. reserved, radio resources in subframe #0. Subframe #0 in a radio frame includes slot #0 and slot #1 of this radio frame.

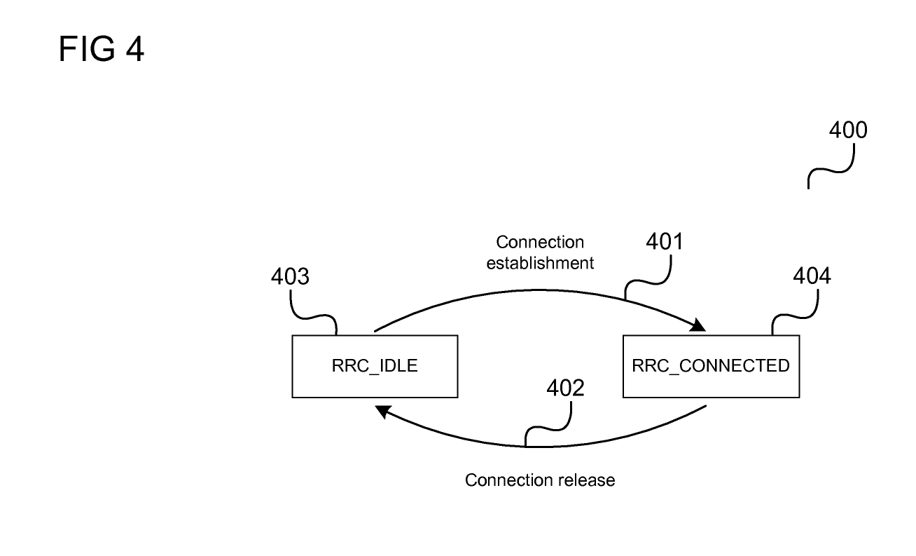

For the efficient control of radio resources and communication connections between a mobile terminal 105 and a base station (eNodeB) 103 two connection states are in one embodiment, according to LTE, specified at the RRC protocol layer, the state RRC_IDLE (also referred to as idle mode) and the state RRC_CONNECTED (also referred to as connected mode). These RRC states and the transitions between these states are illustrated in FIG. 4.

FIG. 4 shows a state transition diagram 400 according to an embodiment.

A first state transition 401 from RRC_IDLE state 403 to RRC_CONNECTED state 404 for example occurs when a communication connection is established between the respective mobile terminal 105 and the respective base station 103.

A second state transition 402 from RRC_CONNECTED state 404 to RRC_IDLE state 403 for example occurs when a communication connection between the respective mobile terminal 105 and the respective base station 103 is released.

RRC_CONNECTED state 404 and RRC_IDLE state 403 may for example be characterized as follows.

RRC_IDLE:
No RRC connection is established
The UE position (i.e. the position of the respective mobile terminal 105) is known by the network (i.e. the E-UTRAN 101 and/or the core network 102) at tracking area level (a tracking area defines a group of radio cells 104 where the mobile terminal 105 in RRC_IDLE state registers and where the mobile terminal 105 is paged in case of an incoming communication attempt);
The mobile terminal 105 performs cell (re-)selection;
The mobile terminal 105 acquires system information which is broadcast in the radio cell 104;
No transmission of user and control data in uplink and downlink by the mobile terminal 105 and the base station 103;
The mobile terminal 105 monitors a paging channel to receive notification about incoming calls or modification of system information;

RRC_CONNECTED:
An RRC connection is established between the mobile terminal 105 and the base station 103;
The mobile terminal 105 is connected to one radio cell 104 only and based on measurements reported by the mobile terminal 105 (e.g. received signal strength of reference signals of detected neighboring radio cells 104) network controlled mobility is performed by explicit handover and cell change order;
The mobile terminal 105 position is known by the network at cell area level;
The mobile terminal 105 acquires system information which are broadcast in the radio cell;
Transmission of user and control data in uplink and downlink;
The mobile terminal 105 monitors a paging channel to receive notification about modification of system information.

The RRC connection is defined as a point-to-point bidirectional connection between RRC peer entities in the mobile terminal 105 and the base station 103. According to one embodiment, there is either none or one RRC connection between a mobile terminal and a base station.

In one embodiment, the communication system 100 may, according to UMTS based on W-CDMA and FDD mode, apply macro-diversity transmission which is also referred to as soft handover. In soft handover the mobile terminal 105 has radio links to more than one mobile radio cell 104. Soft handover is applied for intra-frequency mobile radio cells (i.e. mobile radio cells 104 operating in the same frequency band) only and the mobile terminal 105 may be required to support a maximum of six radio links to different base stations 103. In downlink the same user data is transmitted over all radio links to the mobile terminal 105. In uplink user data is decoded in all involved radio cells and base stations (NodeBs) and delivered to the radio network controller (RNC) for combining. The mobile terminal 105 and the radio access network 101 maintain an “Active Set” (AS) defined as the set of radio links simultaneously involved in the communication between the mobile terminal 105 and the radio access network 101. Based on measurements reported by mobile terminal 105 (e.g. the received signal strength of a common pilot channel of detected neighbouring radio cells 104) the radio access network 101 controls which radio cells 104 to add/replace/remove in the Active Set. The main principle may be seen in that the Active Set should contain only the strongest cells, i.e. the radio cells 104 with the best received signal quality. The main advantage of soft handover may be seen in that the link quality between the base stations 103 and the mobile terminal 105 can significantly be improved. A disadvantage of soft handover may be seen in that radio resources of multiple cells are required, and additional downlink interference is created in multiple radio cells 104. In W-CDMA each radio link may be identified uniquely in downlink by a cell-specific primary scrambling code and in uplink by a mobile terminal specific scrambling code.

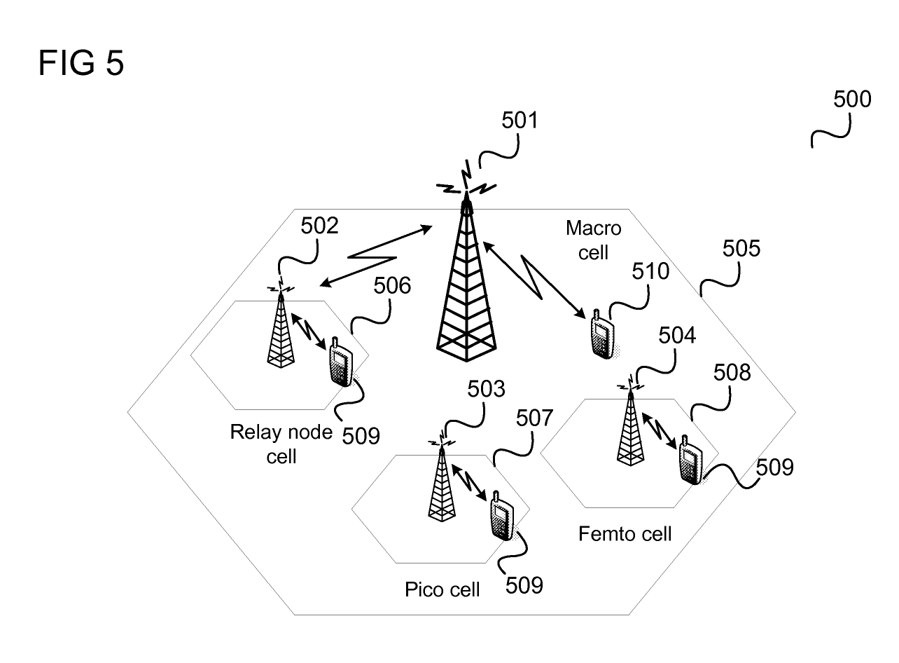

According to one embodiment, the communication system 100 has a heterogeneous network deployment where some of the base stations 103 are low power nodes (e.g. pico eNBs, home eNBs, and/or relay nodes) which are placed throughout a macro cell providing small area coverage and sharing the same spectrum. The macro cell is operated by one of the base stations 103 configured as a macro base station. Such a scenario is illustrated in FIG. 5.

FIG. 5 shows a communication arrangement 500 according to an embodiment.

The communication arrangement includes a first network node 501, e.g. a first base station, operating a macro cell 505, a second network node 502 implemented by a relay node operating a relay node cell 506, a third network node 503 implemented by a pico eNodeB operating a pico cell 507, and a fourth network node 504, e.g. a home eNodeB, operating a femto cell 508. One or more of the network nodes 501 to 504 may for example correspond to one or more of the base stations 104 in FIG. 1. The relay node cell 506, the pico cell 507, and the femto cell 508 are at least partially located in the macro cell 505. A mobile terminal 510 and other mobile terminals 509 for example corresponding to the mobile terminal 105 in FIG. 1 may communicate with the network nodes 501 to 504 depending on the radio cell or radio cells 505 to 508 in which they are located or on which they are camped on. In this example, the mobile terminal 510 is camped on the macro cell 505 and has for example a connection to the first network node 501 (also referred to as macro cell base station) operating the macro cell 505. The other mobile terminals 509 are for example camped on the relay node cell 506, the pico cell 507, or the femto cell 508.

It should be noted that the term network node is used herein to include components of the radio access network such as base stations, relay nodes, home eNodeBs etc. In Release 10 version of the 3GPP standard the following network nodes may be supported according to LTE:
eNodeBs providing macro-cell deployments in different scenarios (urban, rural, indoor), in the following referred to as Macro eNodeBs (MeNB). Regarding the maximum transmission power of Macro eNBs there is no upper limit specified in the 3GPP specifications currently.
Low power nodes, such as Pico eNodeBs (PeNB), Home eNodeBs (HeNB), and Relay Nodes (RN) having much lower maximum transmission power compared to Macro eNBs, e.g. ≦20 dBm for Home eNBs, and ≦24 dBm for Pico eNBs. With respect to power the low power nodes are similar to mobile terminals whose maximum transmission power has for example been specified to be 23 dBm in LTE. These low power nodes may be used to improve the coverage, throughput and capacity of the communication network (compared to the case of a scenario with only macro cells) at low deployment costs. As illustrated in FIG. 5, the low power nodes 506, 507, 508 may be placed throughout the macro cell 505 to provide additional small area coverage in hotspots, at cell edge or coverage holes.

In case the low power nodes 506, 507, 508 located in the macro cell 505 are using the same frequency region as the first network node 501 (e.g. a macro eNB) inter-cell interference coordination (ICIC) for mobile terminals 509, 510 may be a key issue due to fast-changing interference conditions from location to location (e.g. due to uncoordinated deployment of home eNBs), and from time to time (e.g. due to variable traffic load at the low power node 506, 507, 508).

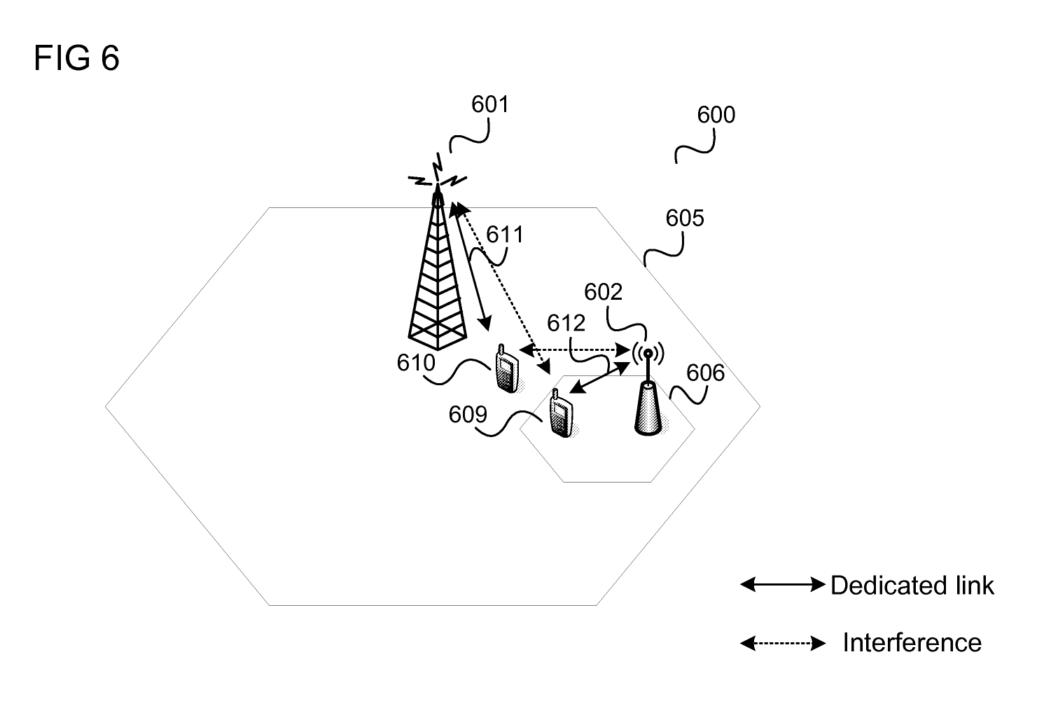

An exemplary uplink/downlink interference scenario that may arise in a heterogeneous network is illustrated in FIG. 6.

FIG. 6 shows a communication arrangement 600 according to an embodiment.

Similarly to the communication arrangement 500 described above with reference to FIG. 5, the communication arrangement includes a first network node 601, e.g. a macro base station (e.g. a macro eNB in case of an LTE communication system), operating a macro cell 605 and a second network node 602 for example operating a femto cell 606.

In this example, a mobile terminal 610 is located in the macro cell 605 and is connected to the first network node 601, i.e. to the macro base station. The mobile terminal 610 may accordingly be seen as a macro mobile terminal (or macro UE in case of an LTE communication system). The mobile terminal 610 has in this example a communication connection 611 to the base station 601. The communication connection 611 is for example a dedicated communication connection for first mobile terminal 610.

The mobile terminal 610 is located in the vicinity of the femto cell 606 and could experience (in worst case substantial) interference in uplink and/or downlink from the femto cell, e.g. from a communication between another mobile terminal 609 and the second network node 602 via, for example another dedicated communication connection 612 between the other mobile terminal 609 and the second network node 602. This interference may degrade the performance of the macro mobile terminal 610 in terms of lower data throughput of the communication between the macro mobile terminal 610 and the macro base station 601. On the other hand, the macro mobile terminal 610 may also cause (in worst case substantial) interference in uplink and/or downlink to the other mobile terminal 609 connected to the second network node 602 operating the femto cell 606.

Various concepts may be used for mitigating interference in heterogeneous networks, for example:
Power control of Home eNBs: A home eNB may reduce the uplink/downlink transmission power in the femto cell it operates to mitigate the inter-cell interference to the macro cell in which it is located. This power adaptation may be carried out autonomously by the home eNB based on own measurements, or may be requested by the macro base station of the macro cell. Power control may be used as a simple and straightforward method for mitigating the interference in heterogeneous networks, but may lead to a reduction of the coverage of the femto cell.
Resource coordination between macro eNB and home eNB: The physical resources (e.g. subframes in time domain, physical resource blocks in frequency domain) may be coordinated/partitioned between a macro eNB and a home eNB located in the macro eNB such that both are communicating using non-overlapping communication resources. This concept may be used as an effective method for mitigating the interference in heterogeneous networks but may lead to degradation of capacity of both the macro eNB and the home eNB. Further, this concept may require a close synchronization between the macro eNB and the home eNB.
Handover of macro UEs to femto cells: Two types of home eNBs may be supported according to LTE: Closed (access mode) home eNBs and Hybrid (access mode) home eNBs. A Closed (access mode) home eNB typically provides services only to its associated CSG (Closed Subscriber Group) UEs, whereas a Hybrid (access mode) home eNB provides services to its associated CSG as well as non-CSG UEs (i.e. to all UEs). These Hybrid (access mode) home eNBs provide a mean for the macro eNB to handover a macro and non-CSG UE located in the vicinity of a hybrid femto cell to the femto cell for interference mitigation purposes. With this concept the communication performance in the macro cell and of the UE can be improved. On the other hand it may degrade the performance of a Hybrid home eNB providing service to its associated CSG UEs.

The above concepts may be seen to have their merits and drawbacks and thus to leave room for optimization.

According to one embodiment, a solution for mitigating inter-cell interference in heterogeneous network deployment scenarios is provided.

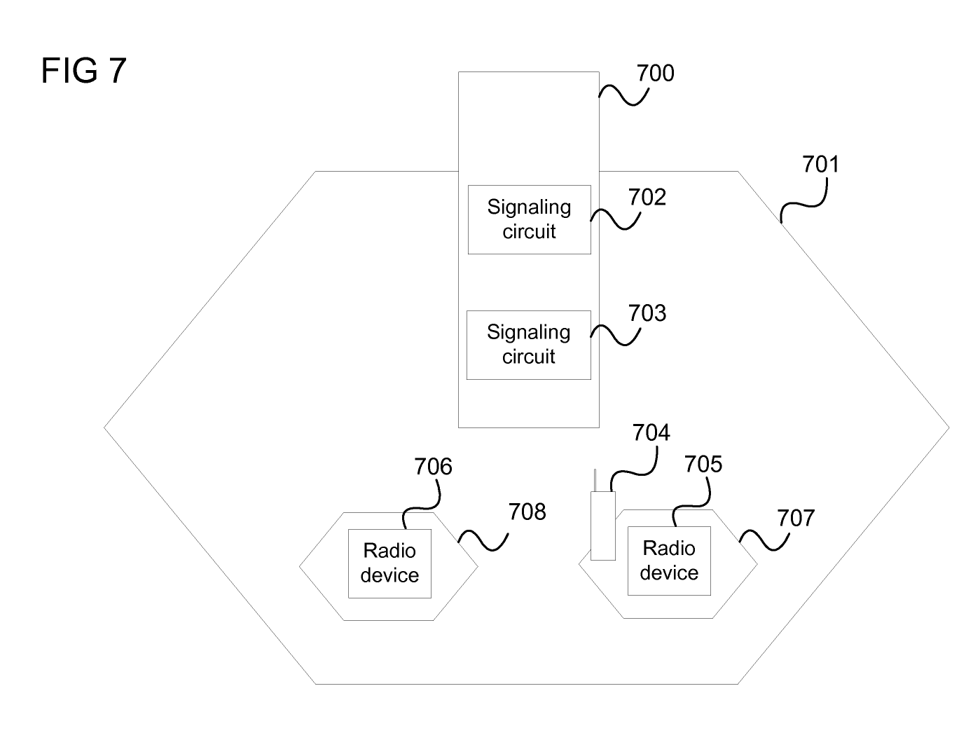

For example, according to one embodiment, a base station is provided as illustrated in FIG. 7.

FIG. 7 shows a base station 700 according to an embodiment.

The base station 700 is a part of a mobile communication network and operates a first radio cell 701 of the mobile communication network.

The base station 700 includes a first signaling circuit 702 configured to signal, for a mobile terminal 704 located in the first radio cell 701 having a communication connection with the mobile communication network via the base station 700, to a first radio device 705 of a plurality of radio devices 705, 706 located in the first radio cell 701, wherein each radio device 705, 706 operates a second radio cell 707, 708 of the mobile communication network, that the first radio device 705 is to provide a communication connection between the mobile terminal 704 and the mobile communication network.

The base station 700 further includes a second signaling circuit 703, configured to signal, for the mobile terminal 704, to at least one second radio device 706 of the plurality of radio devices 705, 706, that the at least one second radio device 706 is to take into account the allocation of radio resources by the first radio device 705 for the communication connection to be provided for the mobile terminal 704 when allocating radio resources for communication within the second radio cell 708 operated by the at least one second radio device 706.

In other words, in one embodiment, a base station hands over a communication connection to a network node located in the radio cell operated by the base station and instructs other network nodes located in the radio cell to take into account the radio resource allocation for the communication connection by the network node. For example, the base station may instruct other network nodes that are neighbours to the network node to not allocate radio resources themselves in case the radio resources have been allocated by the network node. The network node and the other network nodes may form a cluster of network nodes which may be seen to provide the communication connection for the mobile terminal together, wherein the network node may have a special role (e.g. be the “serving” network node) for example in that it performs the scheduling and/or radio resource allocation for the mobile terminal A radio (communication) resource is for example a frequency, a frequency band, or a frequency region or a time interval (e.g. a time slot). For example, a radio resource is given by a combination of a frequency, a frequency band, or a frequency region with a time interval. A radio (communication) resource is for example a physical resource block, e.g. according to LTE, such as a physical resource block according to OFDMA/SC-FDMA data transmission.

The first radio cell is for example a macro cell.

The radio devices of the plurality of radio devices are for example base stations characterized by restricted transmission power and providing a small coverage area, e.g. low power nodes.

According to one embodiment, the coverage area of the second radio cells lies within the coverage area of the first radio cell.

According to one embodiment, the first signaling circuit and the second signaling circuit are implemented by a message transmitting circuit of the base station, wherein the message transmitting circuit is configured to generate a message indicating that the first radio device is to provide a communication connection between the mobile terminal and the mobile communication network and indicating that the at least one second radio device is to take into account the allocation of radio resources by the first radio device for the communication connection to be provided for the mobile terminal when allocating radio resources for communication within the second radio cell operated by the at least one second radio device and to send the message to the first radio device and the at least one second radio device.

The message for example includes at least one of an identification of the first radio device and an identification of the second radio device, for example at least one of a physical layer cell identity of the first radio device and a physical layer cell identity of the second radio device.

According to one embodiment, the message includes an identification of the mobile terminal.

According to one embodiment, the base station further includes a determining circuit configured to determine a set of one or more second radio devices of the plurality of radio devices which are to take into account the allocation of radio resources by the first radio device for the communication connection to be provided for the mobile terminal when allocating radio resources for communication within the second radio cells operated by the one or more second radio devices of the determined set of second radio devices.

The determining circuit is for example configured to determine the set of one or more second radio devices based on a predetermined radio transmission criterion.

According to one embodiment, the determining circuit is configured to determine the set of one or more second radio devices based on radio transmission quality measurements of radio transmissions in the first radio cell.

In one embodiment, the second signaling circuit is configured to signal to the determined set of one or more second radio devices that they are to take into account the allocation of radio resources by the first radio device for the communication connection to be provided for the mobile terminal when allocating radio resources for communication within the second radio cells operated by the set of one or more second radio devices.

The second signaling circuit is for example configured to signal an identification of the set of one or more second radio devices to the plurality of radio devices.

The identification of the set of one or more second radio devices is for example a physical layer cell identity.

In one embodiment, the first signaling circuit is configured to signal an indication of the radio resources to be allocated by the first radio device for the communication connection to be provided for the mobile terminal to the first radio device.

In one embodiment, the first signaling circuit is configured to signal an indication of the radio resources to be allocated by the first radio device for the communication connection to be provided for the mobile terminal to the at last one second radio device.

The second signaling circuit is for example configured to signal to the at least one second radio device of the plurality of radio devices, that the at least one second radio device must not allocate radio resources for communication within the second radio cell operated by the at least one second radio device when the radio resources have been allocated by the first radio device for the communication connection.

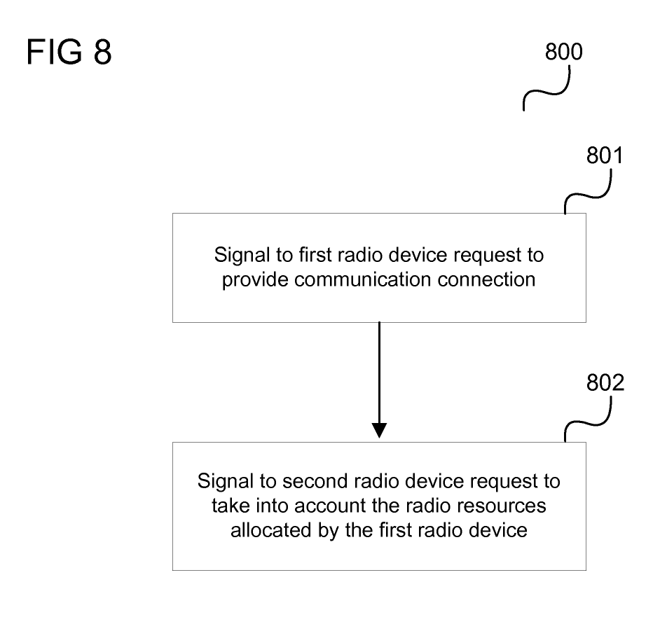

The base station 700 may for example carry out a method as illustrated in FIG. 8.

FIG. 8 shows a flow diagram 800 according to an embodiment.

The flow diagram 800 illustrates a method for controlling radio resource allocation.

In 801, a base station which operates a first radio cell of a mobile communication network signals, for a mobile terminal located in the first radio cell having a communication connection with the mobile communication network via the base station, to a first radio device of a plurality of radio devices located in the first radio cell, wherein each radio device operates a second radio cell of the mobile communication system, that the first radio device is to provide a communication connection between the mobile terminal and the mobile communication network.

In 802, the base station signals, for the mobile terminal, to at least one second radio device of the plurality of radio devices, that the at least one second radio device is to take into account the allocation of radio resources by the first radio device for the communication connection to be provided for the mobile terminal when allocating radio resources for communication within the second radio cell operated by the at least one second radio device.

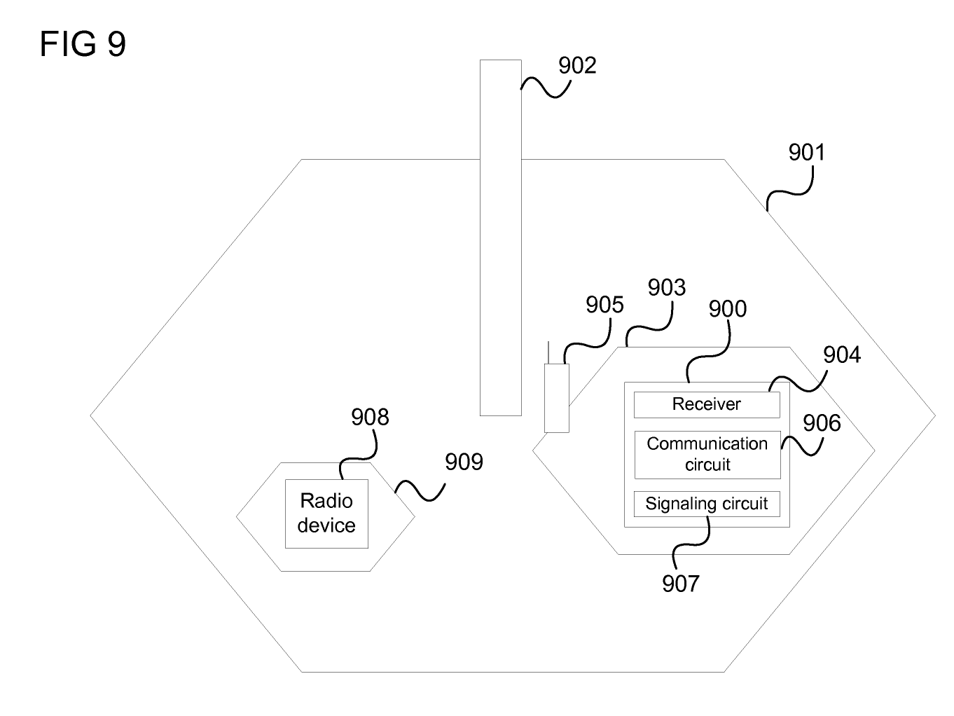

The first radio device 705 for example has the structure as illustrated in FIG. 9.

FIG. 9 shows a radio device 900 according to an embodiment.

The radio device 900 is located in a first radio cell 901 of the mobile communication network operated by a base station 902 and the radio device 900 operates a second radio cell 903 of the mobile communication network. The radio device 900 includes a receiver 904 configured to receive from the base station 902, for a mobile terminal 905 located in the first radio cell having a communication connection with the mobile communication network via the base station 902, a request to provide a communication connection between the mobile terminal 905 and the mobile communication network.

The radio device 900 further includes a communication 906 circuit configured to provide a communication connection between the mobile terminal 905 and the mobile communication network in response to the request.

Further, the radio device 900 includes a signaling circuit 907 configured to signal to at least one other radio device 908 located in the first radio cell 901 and operating another radio cell 909 of the mobile communication network the allocation of radio resources by the radio device 900 for the communication connection.

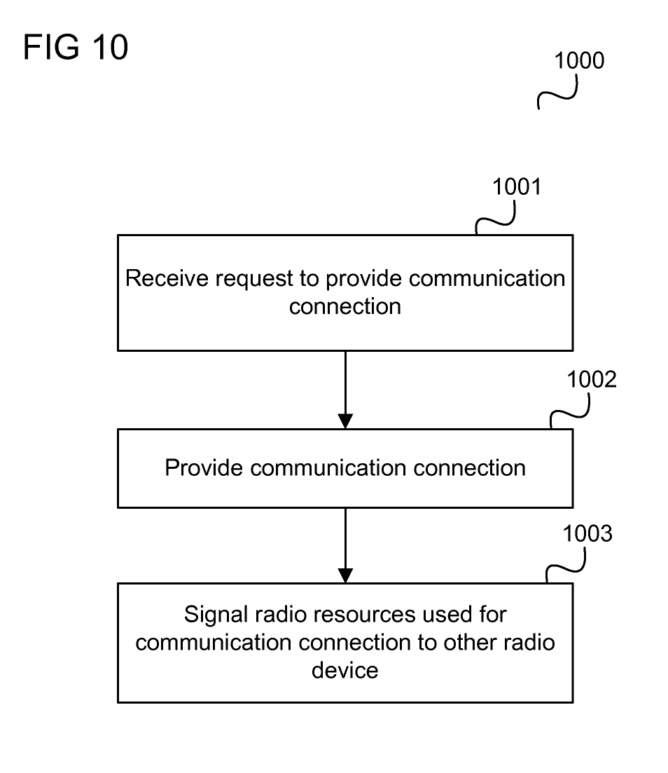

In one embodiment, the first radio device 705 (e.g. corresponding to the radio device 900 as illustrated in FIG. 9) carries out a method as illustrated in FIG. 10.

FIG. 10 shows a flow diagram 1000 according to an embodiment.

The flow diagram 1000 illustrates a method for providing a communication connection.

In 1001, a radio device of a mobile communication network located in a first radio cell of the mobile communication network operated by a base station and operating a second radio cell of the mobile communication network, receives from the base station, for a mobile terminal located in the first radio cell having a communication connection with the mobile communication network via the base station, a request to provide a communication connection between the mobile terminal and the mobile communication network.

In 1002, the radio device provides a communication connection between the mobile terminal and the mobile communication network in response to the request.

In 1003, the radio device signals to at least one other radio device located in the first radio cell and operating another radio cell of the mobile communication network the allocation of radio resources by the radio device for the communication connection.

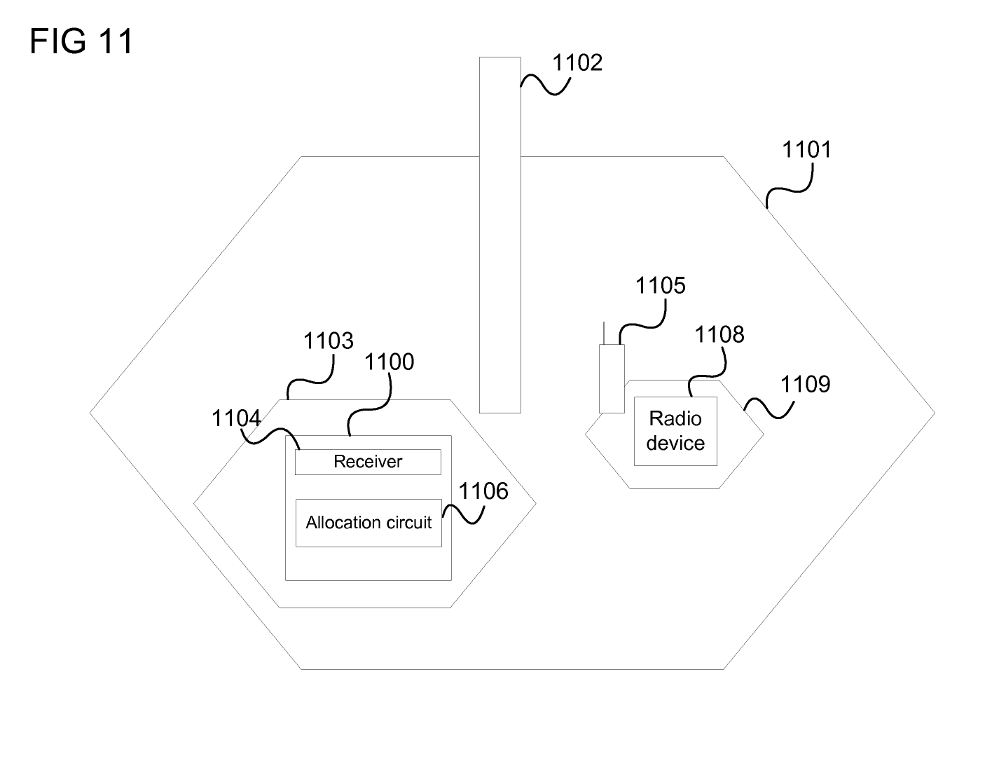

The second radio device 706 for example has the structure as illustrated in FIG. 11.

FIG. 11 shows a radio device 1100 according to an embodiment.

The radio device 1100 is located in a first radio cell 1101 of the mobile communication network operated by a base station 1102 and the radio device 1100 operates a second radio cell 1103 of the mobile communication network.

The radio device 1100 includes a receiver 1104 configured to receive, from the base station 1102, a request to take the allocation of radio resources by another first radio device 1108 for a communication connection between the mobile communication network and a mobile terminal 1105 provided by the other radio device in a second radio cell 1109 into account when allocating radio resources for communication within the second radio cell 1103 operated by the radio device 1100 and configured to receive from the other radio device 1108 an indication of the allocation of radio resources by the other radio device 1108 for the communication connection. The radio device 1100 further includes an allocation circuit 1106 configured to allocate communication resources for the communication within the second radio cell 1103 taking into account the allocation of radio resources by the other radio device 1108 for the communication connection.

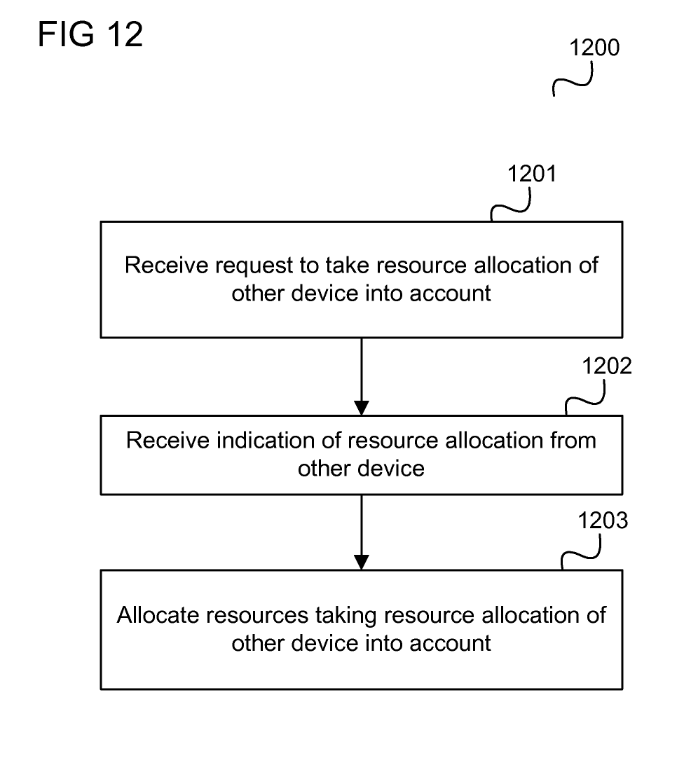

In one embodiment, the second radio device 706 (e.g. corresponding to the radio device 1100 as illustrated in FIG. 11) carries out a method as illustrated in FIG. 12.

FIG. 12 shows a flow diagram 1200 according to an embodiment.

The flow diagram 1200 illustrates a method for allocating radio resources.

In 1201, a radio device of a mobile communication network, wherein the radio device is located in a first radio cell of the mobile communication network operated by a base station and wherein the radio device operates a second radio cell of the mobile communication network, receives, from the base station, a request to take the allocation of radio resources by another first radio device for a communication connection between the mobile communication network and a mobile terminal provided by the other radio device into account when allocating radio resources for communication within the second radio cell operated by the radio device.

In 1202, the radio device receives from the other radio device an indication of the allocation of radio resources by the other radio device for the communication connection.

In 1203, the radio device allocates communication resources for the communication within the second radio cell taking into account the allocation of radio resources by the other radio device for the communication connection.

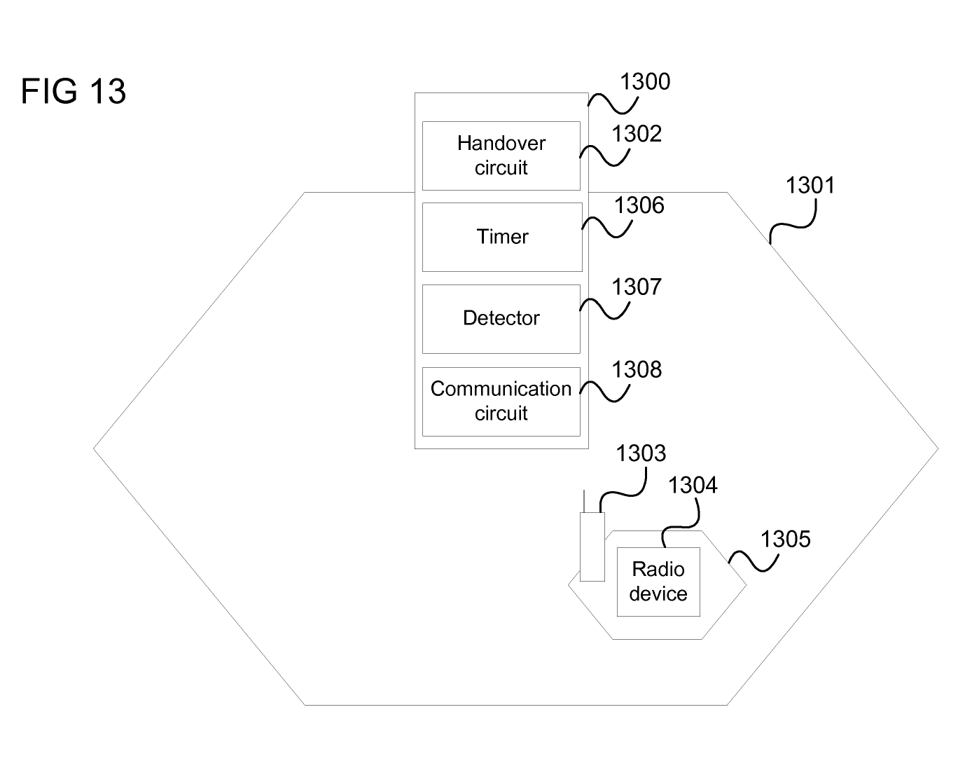

According to one embodiment, a base station is provided as illustrated in FIG. 13.

FIG. 13 shows a base station 1300 according to an embodiment.

The base station 1300 is part of a mobile communication network and operates a first radio cell 1301 of the mobile communication network.

The base station 1300 includes a handover circuit 1302 configured to hand over a communication connection between a mobile terminal 1303 located in the first radio cell 1301 and the mobile communication network to a radio device 1304 operating a second radio cell 1305 of the mobile communication network.

Further, the base station 1300 includes a timer 1306 configured to measure the time since the handover of the communication connection to the radio device 1304.

Additionally, the base station 1300 includes a detector 1307 configured to detect whether the time since the handover of the communication connection to the radio device 1304 has reached a predetermined threshold.

The base station 1300 further includes a communication circuit 1308 configured to take over the communication connection between the mobile terminal 1303 and the mobile communication network from the radio device 1304 when it has been detected that the time since the handover of the communication connection to the radio device 1304 has reached a predetermined threshold.

In other words, in one embodiment, the communication connection is handed over by the base station for a certain time, e.g. a certain minimum time. The base station may for example update the timer (or update the predetermined threshold) such that the time until the communication connection is handed back to the base station may for example be increased (e.g. by the base station increasing the predetermined threshold).

According to one embodiment, the base station includes a determining circuit configured to determine the threshold, for example based on a predetermined radio transmission criterion, e.g. based on the traffic and/or interference in the first radio cell 1301 etc.

The base station may include a signaling circuit configured to signal the threshold to the radio device 1304. The base station may for example select a certain value (from a plurality of possible values) for the threshold and continuously signal the threshold to the radio device, even after the handover has taken place such that the base station may control how long the radio device should (still) provide the communication connection before handing it back to the base station.

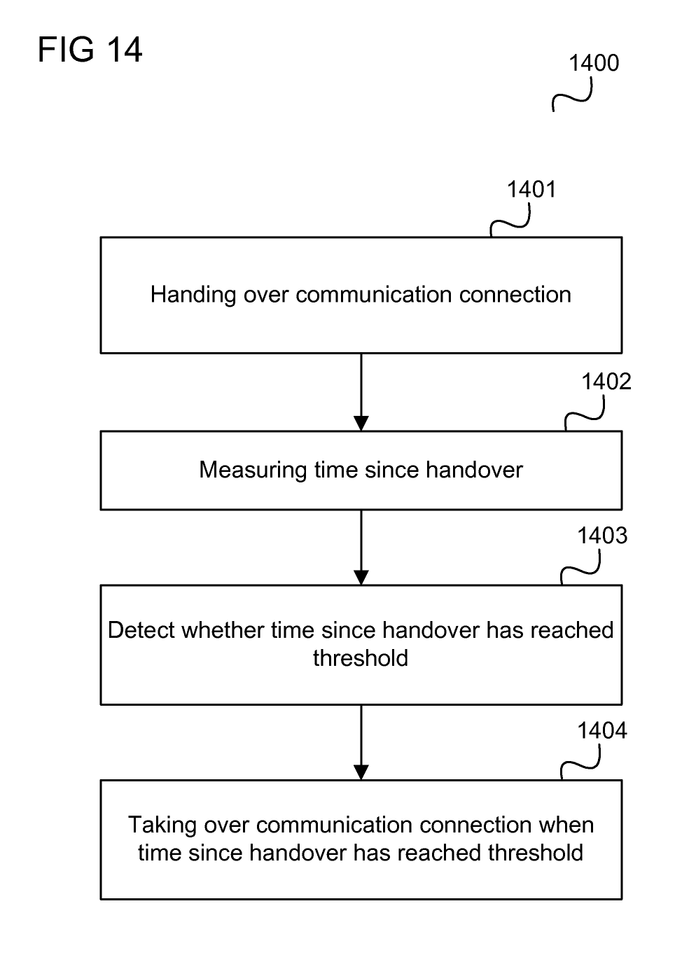

The base station 1300 for example carries out a method as illustrated in FIG. 14.

FIG. 14 shows a flow diagram 1400 according to an embodiment.

The flow diagram 1400 illustrates a method for handing over a communication connection, for example carried out by a base station of a mobile communication network and operating a first radio cell of the mobile communication network.

In 1401, a communication connection between a mobile terminal located in the first radio cell and the mobile communication network is handed over to a radio device operating a second radio cell of the mobile communication network.

In 1402 the time since the handover of the communication connection to the radio device is measured.

In 1403, it is detected whether the time since the handover of the communication connection to the radio device has reached a predetermined threshold.

In 1404, the communication connection between the mobile terminal and the mobile communication network is taken over from the radio device when it has been detected that the time since the handover of the communication connection to the radio device has reached a predetermined threshold.

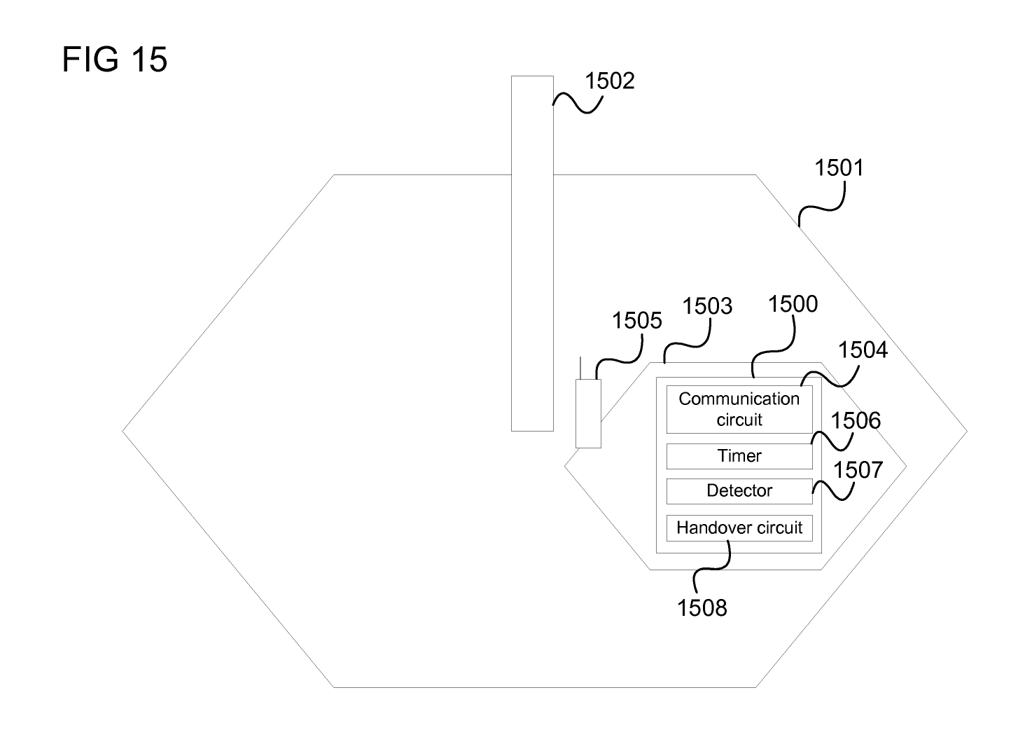

The radio device 1304 may for example have the structure as illustrated in FIG. 15.

FIG. 15 shows a radio device 1500 according to an embodiment.

The radio device 1500 is part of a mobile communication network and is located in a first radio cell 1501 operated by a base station 1502 of the mobile communication network and operates a second cell 1503 of the mobile communication network.

The radio device 1500 includes a communication circuit 1504 configured to take over a communication connection between a mobile terminal 1505 located in the first radio cell 1501 and the mobile communication network from the base station 1502.

The radio device 1500 further includes a timer 1506 configured to measure the time since the taking over of the communication connection to the radio device.

Furthermore, the radio device 1500 includes a detector 1507 configured to detect whether the time since the taking over of the communication connection to the radio device 1500 has reached a predetermined threshold.

The radio device 1500 further includes a handover circuit 1508 configured to hand over the communication connection between the mobile terminal and the mobile communication network to the base station 1502 when it has been detected that the time since the taking over of the communication connection to the radio device has reached a predetermined threshold.

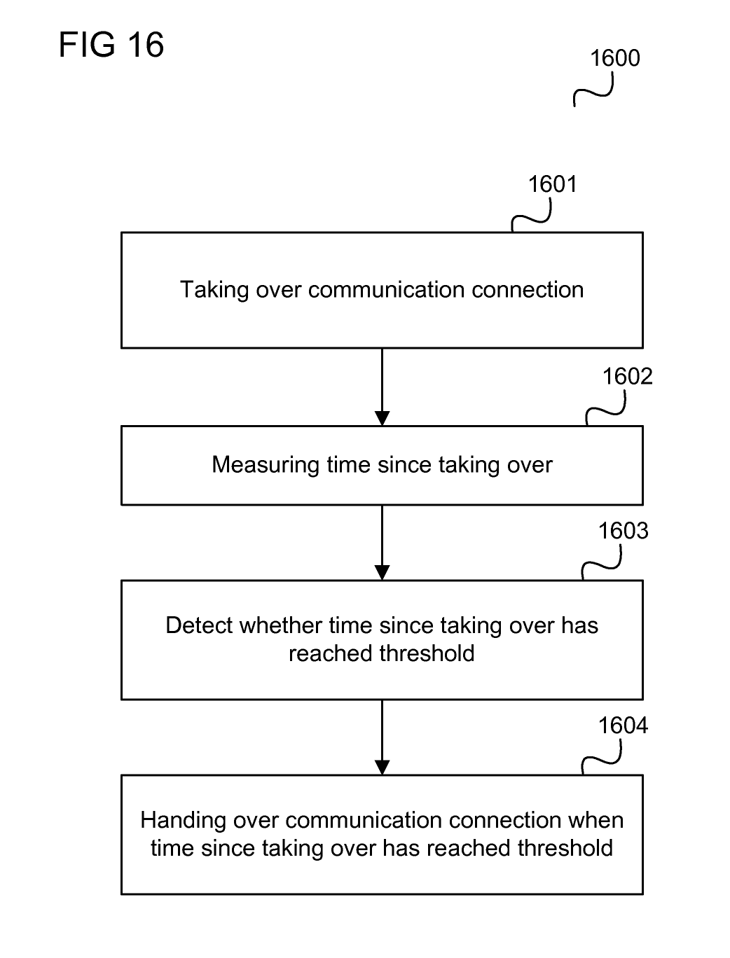

The radio device 1500 for example carries out a method as illustrated in FIG. 16.

FIG. 16 shows a flow diagram 1600 according to an embodiment.

The flow diagram 1600 illustrates a method for providing a communication connection.

The method is for example carried out by a radio device that is part of a mobile communication network and that is located in a first radio cell operated by a base station of the mobile communication network and that operates a second cell 1503 of the mobile communication network.

In 1601, a communication connection between a mobile terminal located in the first radio cell and the mobile communication network is taken over from the base station.

In 1602, the time since the taking over of the communication connection to the radio device is measured.

In 1603, it is detected whether the time since the taking over of the communication connection to the radio device has reached a predetermined threshold.

In 1604, the communication connection between the mobile terminal and the mobile communication network is handed over to the base station when it has been detected that the time since the taking over of the communication connection to the radio device has reached a predetermined threshold.

According to one embodiment, a network component of a mobile communication network with a plurality of radio devices, each radio device operating a radio cell, is provided. The network component includes a signaling circuit configured to signal to the plurality of radio devices that the radio devices are to communicate with at least one mobile terminal based on a radio cell identification which is equal for all radio cells operated by the radio devices of the plurality of radio devices.

For example, the network component is a base station, e.g. corresponding to the base station 700 shown in FIG. 7. The network component may, in other embodiments, be realized by another network component in addition or alternatively to a base station.

Illustratively, a common cell identification is used for a plurality of radio cells operated by a plurality of radio devices. For example, a plurality of radio cells operated by a plurality of radio devices are grouped to a cell cluster and are assigned a common cell identification.

The radio cell identification is for example a physical layer cell identification, e.g. a common physical layer cell identification of the radio cells operated by the radio devices.

The signaling circuit is for example configured to signal to the plurality of radio devices that the radio devices are to communicate with the at least one mobile terminal by scrambling and/or descrambling data to be transmitted to and/or received from the mobile terminal using the radio cell identification.

According to one embodiment, a mobile terminal is provided including a memory storing a first radio cell identification and a second radio cell identification and a transceiver configured to perform synchronization with a first radio device based on the first radio cell identification and to perform downlink and uplink communication with the first radio device and a second radio device based on the second radio cell identification.

Illustratively, the mobile terminal uses a first radio cell identification for communicating with a first radio device, e.g. for receiving control signals from the first radio device, and uses a second radio cell identification for communicating in uplink and downlink (e.g. for useful data transmission) with the first radio device and one or more second radio devices. The mobile terminal may for example correspond to the mobile terminal 704 and the radio devices may for example correspond to the radio devices 705, 706 as illustrated in FIG. 7.

The first radio device and the second radio device for example operate radio cells.

The first radio cell identification and the second radio cell identification are for example physical layer cell identifications.

The transceiver is for example configured to scramble data in uplink downlink communication with the first radio device and the second radio device using the second identification.

According to one embodiment, a method corresponding to the network component and/or the mobile terminal is provided.

It should be noted that embodiments described in context with one of the base stations, the radio devices, the network component, the mobile terminal, or the methods are analogously valid for the other base stations, the other radio devices, the other network components, the other mobile terminals, and the other methods.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In various embodiments, the radio devices may be configured as a home base station, e.g. as a Home NodeB, e.g. as a Home eNodeB. In an example, a ‘Home NodeB’ may be understood in accordance with 3GPP (Third Generation Partnership Project) as a trimmed-down version of a cellular mobile radio base station optimized for use in residential or corporate environments (e.g., private homes, public restaurants or small office areas). In various examples throughout this description, the terms ‘Home Base Station’, ‘Home NodeB’, ‘Home eNodeB’, ‘Femto Cell’, ‘Femto Cell Base Station’ are referring to the same logical entity and will be used interchangeably throughout the entire description. Femto-Cell Base Stations (FC-BS) may be provided in accordance with a 3GPP standard, but may also be provided for any other mobile radio communication standard, for example for IEEE 802.16m.

The so-called ‘Home Base Station’ concept shall support receiving and initiating cellular calls at home, and uses a broadband connection (typically DSL (dynamic subscriber line), cable modem or fibre optics) to carry traffic to the operator's core network bypassing the macro network architecture (including legacy NodeBs or eNodeBs, respectively), i.e. the legacy UTRAN (UMTS (Universal Mobile Telecommunications System) Terrestrial Radio Access Network) or E-UTRAN, respectively. Femto Cells shall operate with all existing and future handsets rather than requiring customers to upgrade to expensive dual-mode handsets or UMA (Unlicensed Mobile Access) devices.

From the customer's perspective, ‘Home NodeBs’ offer the user a single mobile handset with a built-in personal phonebook for all calls, whether at home or elsewhere. Furthermore, for the user, there is only one contract and one bill. Yet another effect of providing ‘Home NodeBs’ may be seen in the improved indoor network coverage as well as in the increased traffic throughput. Moreover, power consumption may be reduced as the radio link quality between a handset and a ‘Home Base Station’ may be expected to be much better than the link between a handset and legacy ‘NodeB’.

Access to a ‘Home NodeB’ may for example be allowed for a closed user group only, i.e. the communication service offering may be restricted to employees of a particular company or family members, in general, to the members of the closed user group. This kind of ‘Home Base Stations’ may be referred to as ‘Closed Subscriber Group Cells’ (CSG Cells) in 3GPP. A mobile radio cell which indicates being a CSG Cell may need to provide its CSG Identity to the mobile radio communication terminal devices (e.g. the UEs). Such a mobile radio cell may only be suitable for a mobile radio communication terminal device if its CSG Identity is e.g. listed in the mobile radio communication terminal device's CSG white list (a list of CSG Identities maintained in the mobile radio communication terminal device or in an associated smart card indicating the mobile radio cells which a particular mobile radio communication terminal device is allowed to use for communication). In various embodiments, a home base station may be a consumer device that is connected to the mobile radio core network via fixed line (e.g. DSL) or wireless. It may provide access to legacy mobile devices and increase the coverage in buildings and the bandwidth per user. In various embodiments, a home base station may be operated in open or closed mode. In closed mode the home base station may provide access to a so-called closed subscriber group (CSG) only. Examples for such closed subscriber groups are families or some or all employees of a company, for example.

A ‘Femto Cell’ entity or ‘Home Base Station’ entity will usually be a box of small size and physically under control of the user, in other words, out of the MNO's (mobile network operator) domain, it could be used nomadically, i.e. the user may decide to operate it in his apartment, but also in a hotel when he is away from home, e.g. as a business traveler. Additionally a ‘Home NodeB’ may be operated only temporarily, i.e. it can be switched on and off from time to time, e.g. because the user does not want to operate it over night or when he leaves his apartment.

According to one embodiment, a solution for mitigating inter-cell interference in a heterogeneous network deployment scenario, e.g. in a cellular communication system having a heterogeneous architecture such as the communication system 500 shown in FIG. 5, is provided. According to one embodiment, the concepts power control of low power nodes, resource coordination and handover between network nodes may be seen to be combined in an effective manner.

Referring to FIG. 6, according to one embodiment, to reduce interference in the macro cell 605 the macro base station decides to temporarily handover the first communication connection between itself and the macro mobile terminal 610 to a cluster of low power node cells or low power nodes. The size of the cluster of low power node cells (i.e. the number of low power nodes in the cluster of low power nodes) is for example determined by the macro base station 601 and for example based on measurements received by the macro base station 601 from one or more mobile terminals.

In one embodiment, the following parameters are sent from the macro base station 601 to the macro mobile terminal 610, e.g. by means of an RRC handover command message:
A cell-specific physical layer cell identity which may be used by the mobile terminal 610 to synchronize to a specific low power node (referred to as “serving node” or, for the respective radio cell operated by the low power node, the “serving node cell”) within the cluster of low power nodes. According to one embodiment, all low power nodes within the cluster have the same frame and slot timing, e.g. the same timing with respect to the frame structure they are using, e.g. the frame structure described with reference to FIG. 2.
A common physical layer cell identity which may be used by the mobile terminal 610 for scrambling of data to be transmitted in uplink, e.g. on PUSCH, and descrambling of data to be received in downlink, e.g. on PDSCH.

According to one embodiment, the following parameters are sent from the macro base station 601 to the cluster of low power nodes, e.g. through a handover indication message:
The identity of the mobile terminal 610 for which the communication connection is transferred from the macro cell 605 (i.e. from the macro base station 601) to the cluster of low power node cells (i.e. the cluster of low power nodes).
The number and location of physical resources in frequency domain (e.g. an indication of physical resource blocks) for uplink and/or downlink to be used for the connection between the mobile terminal 610 and the cluster of low power node cells. These physical resources are for example determined by the base station 601, e.g. based on the traffic load and interference situation in the macro cell 605.
The upper limit of transmission power in uplink and/or downlink for the connection between the mobile terminal 610 and the cluster of low power node cells.
Two physical layer cell identities: one cell-specific and one common cell identity.
   The cell-specific cell identity may be used to determine the serving node cell within the cluster of low power node cells. The serving node cell (i.e. the serving node) is for example responsible for the scheduling of PUSCH/PDSCH transmission for the mobile terminal 610. Scheduling may be based on the physical resources in frequency domain (e.g. physical resource blocks) in uplink and/or downlink predefined by macro base station 601.
   The common cell identity may be used to determine all low power node cells within the cluster of low power node cells. Further, the common cell identity may be used for descrambling of data to be received in uplink, e.g. on PUSCH, and for scrambling of data to be transmitted in downlink, e.g. on PDSCH. For example, transmissions in downlink, e.g. PDSCH transmissions, are only performed by the serving node. The data received in uplink, e.g. on PUSCH, is for example decoded by all low power nodes within the cluster of low power nodes and forwarded to the mobile communication network (e.g. to a core network) if correctly received. In the mobile communication network (e.g. in the core network) all correctly received data may be collected and duplicate data may be discarded.
Depending on the type of the low power nodes the handover indication message may be sent over following interfaces:
   X2 interface between the macro base station 601 and the second network node 602 if the second network node 602 is a Pico eNB;
   S1 interface between the macro base station 601 and the second network node 602 if the second network node is a home eNB since there may be no X2 interface between macro base stations and Home eNBs;
   Un interface between Macro eNBs and the second network node 602 if the second network node 602 is a relay node.

According to one embodiment, a timer value T_{HO} for determining the minimum duration of the (e.g. dedicated) communication connection between the mobile terminal 610 and the cluster of low power nodes. The timer value is for example set by the base station 601, e.g. based on the traffic load and interference situation in the macro cell. Possible values of the timer T_{HO} are for example 1, 2, 5, 10, 20, 50, 100, . . . , or infinite (e.g. in seconds). The value “infinite” (or “infinity”) may mean that a handover of the communication connection back to the base station is not allowed. The timer is for example initially started at start of transmissions between the mobile terminal 610 and the cluster of low power node cells in uplink and/or downlink on PUSCH or PDSCH, respectively. The timer is for example stopped and restarted when a new timer value is received from the base station 601. When the timer expires without a new timer value having been received, the dedicated connection of the mobile terminal 610 is for example transferred back to the base station 601. For this, for example, the serving node sends a corresponding RRC handover command message to the mobile terminal 610.

In other words, according to one embodiment, in order to reduce interference in the macro cell the macro base station 601 may decide to temporarily handover a (dedicated) communication connection of the macro mobile terminal 610 to a cluster of low power nodes. After expiry of a timer the communication connection of the mobile terminal 610 is transferred back to the macro base station 601. The size of the cluster of low power nodes and the duration of the communication connection between the mobile terminal 610 and the cluster of low power nodes may be determined by the macro base station 601. The following parameters are for example sent from the macro base station 601 to the macro mobile terminal 610 and the cluster of low power nodes, respectively:
Two physical layer cell identities: one cell-specific and one common cell identity. Cell search and synchronization may be based on the cell-specific cell identity. The uplink and/or downlink transmissions between the mobile terminal 610 and the cluster of low power nodes may be based on the common cell identity.
The identity of the mobile terminal 610 for which the communication connection is transferred from macro cell to the cluster of low power node cells.
The number and location of physical resources in frequency domain (e.g. physical resource blocks) in uplink and/or downlink to be used for the communication connection between the mobile terminal 610 and the cluster of low power nodes.
The upper limit of transmission power in uplink and/or downlink for the communication connection between the mobile terminal and the cluster of low power nodes.
A timer value T_{HO} for determining the minimum duration of the dedicated connection between the mobile terminal and the cluster of low power nodes.

One embodiment allows the macro base station 601 to reduce the interference in the macro cell 605 it is operating. Furthermore, according to one embodiment, the impact of interference originated from a (dedicated) communication connection between the mobile terminal 610 and the cluster of low power node cells on the macro cell can be reduced.

In the following, an embodiment is described based on an LTE mobile communication network based on OFDMA/TDMA in downlink, SC-FDMA/TDMA in uplink, and operating in FDD mode. It is assumed that in at least one radio cell, the mobile communication network has a heterogeneous network deployment as described with reference to FIG. 5 in which an LTE UE (e.g. corresponding to the mobile terminal 510) is located in a macro cell (e.g. corresponding to the macro cell 505) and is connected to a macro base station (e.g. corresponding to the macro base station 501). In addition, low power nodes, e.g. corresponding to the network nodes 502, 503, 504, such as Pico eNBs, Home eNBs, Relay Nodes are placed throughout the macro cell 505 and share the same spectrum, i.e. share the same frequency communication resources for downlink and/or uplink communication with mobile terminals 509.

It is assumed that the macro UE 510 is located in the vicinity of a hybrid femto cell (e.g. corresponding to the femto cell 508) operated by one of the low power nodes, e.g. the low power node 504. Further, as explained with reference to FIG. 6, it is assumed that the macro UE 510 experiences substantial interference in uplink and/or downlink from the hybrid femto cell 508, i.e. from communication between the low power node 504 operating the hybrid femto cell 508 and, for example, another mobile terminal 509. Further, it is assumed that the macro UE 510 also causes substantial interference in uplink and/or downlink to one or more mobile terminals 509 connected to the low power node 504 operating the hybrid femto cell 508.

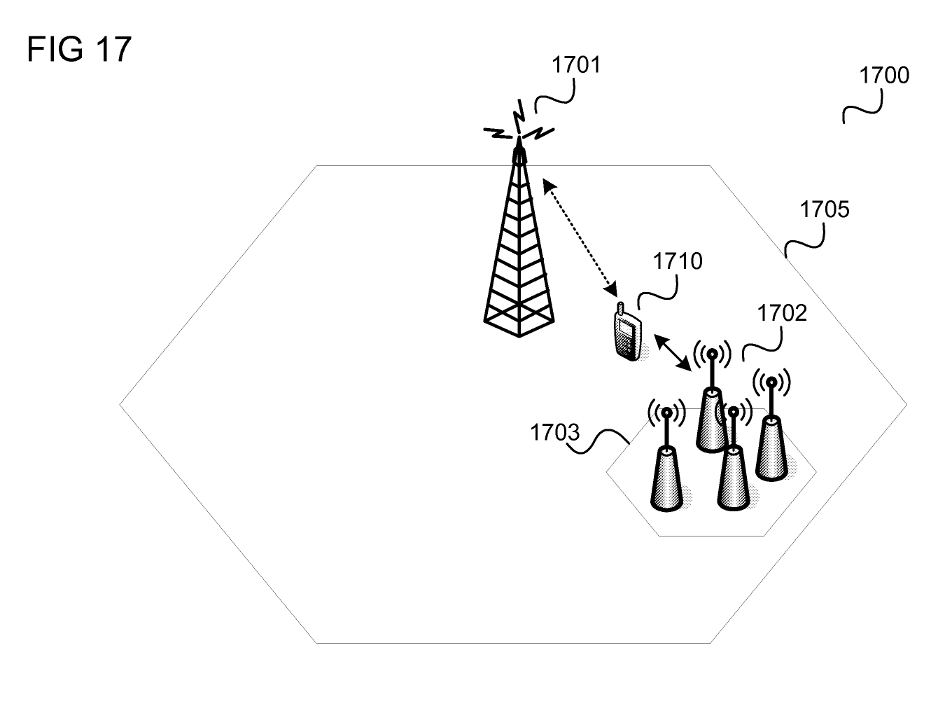

According to one embodiment, the low power nodes 502, 503, 504 are grouped to a cluster of low power nodes. This is illustrated in FIG. 17.

FIG. 17 shows a communication system 1700 according to an embodiment.

The communication system 1700 includes a macro base station 1701 (corresponding to the macro base station 501) operating a macro radio cell 1705 (corresponding to the macro radio cell 505) and a mobile terminal 1710 (corresponding to the mobile terminal 510). Low power nodes (corresponding to the network nodes 502, 503, 504) are grouped to a cluster of low power nodes (or low power node cluster) 1702. Each of the low power nodes of the low power node cluster 1702 may operate a radio cell. For example, a radio cell 1703 is operated by one of the low power nodes of the low power node cluster 1702.

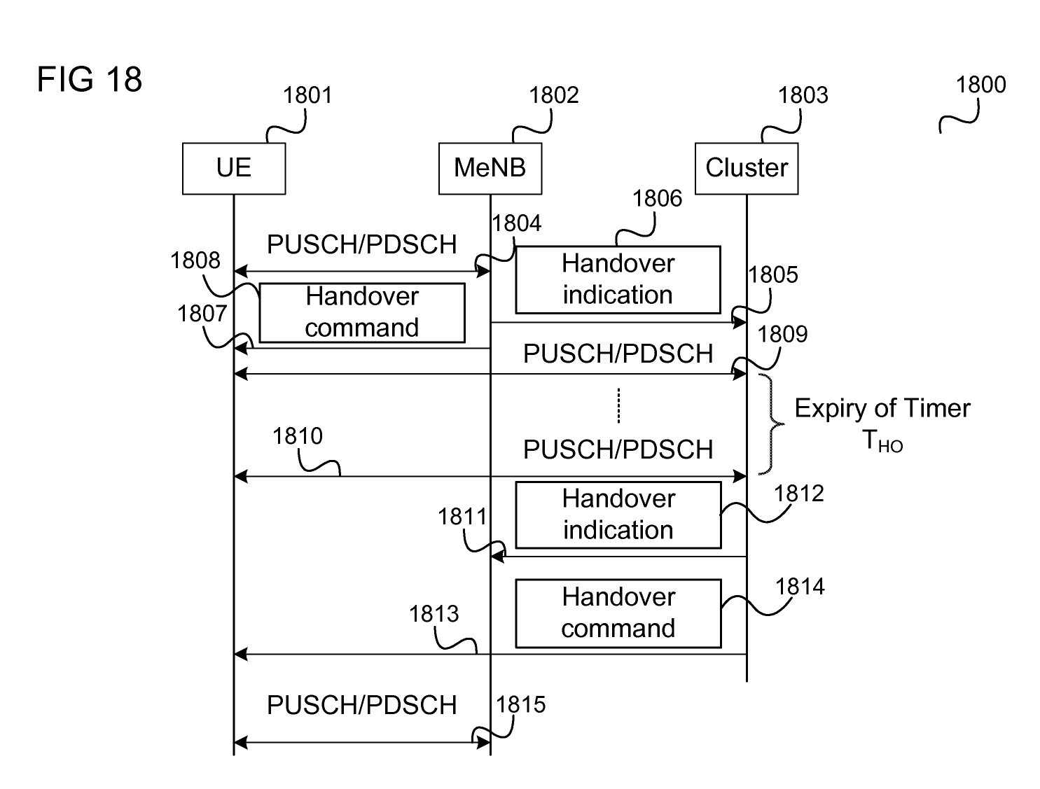

For reducing interference in the macro radio cell 1705, according to one embodiment, the message flow as illustrated in FIG. 18 is carried out.

FIG. 18 shows a message flow diagram 1800 according to an embodiment.

The message flow takes place between a mobile terminal 1801, e.g. corresponding to the mobile terminal 1710 of the communication system 1700 shown in FIG. 17, a macro base station 1802, e.g. corresponding to the macro base station 1701 of the communication system 1700 shown in FIG. 17, and a cluster of low power nodes 1803, e.g. corresponding to the low power node cluster 1702 of the communication system 1700 shown in FIG. 17.

In 1804, uplink and/or downlink transmissions on PUSCH/PDSCH take place between the mobile terminal 1801 and the macro base station 1802 via a dedicated communication connection. It is assumed that based on measurements received from the mobile terminal 1801, the macro base station 1802 observes substantial increase of interference from one or more hybrid femto cells in the vicinity of the mobile terminal 1801. In order to reduce interference in the macro cell that it operates, the base station 1802 decides to temporarily handover the dedicated connection for the mobile terminal 1801 to the low power node cluster 1803, which is assumed to be a cluster of hybrid femto cells in this example. The size of the cluster of hybrid femto cells (i.e. the number of cells or low power nodes of the cluster) is for example determined by the base station 1802.

In 1805, the following parameters are sent from the base station 1802 to the low power node cluster 1803 by means of a first handover indication message 1806 via the S1 interface:
The identity of the mobile terminal 1801 for which the dedicated communication connection is transferred from the base station 1802 to the cluster of hybrid femto cells 1803.
The number and location of physical resources in frequency domain (i.e. physical resource blocks) in uplink and/or downlink to be used for the communication connection between the mobile terminal 1801 and the cluster of hybrid femto cells 1803.
The upper limit of transmission power in uplink and/or downlink for the connection between the mobile terminal 1801 and the cluster of hybrid femto cells 1803.
Two physical layer cell identities: one cell-specific and one common cell identity.
   The cell-specific cell identity specifies a serving low power node (or, accordingly, a serving cell) of the low power nodes of the low power node cluster 1803. The serving low power node is responsible for the scheduling of PUSCH/PDSCH transmission for the mobile terminal 1801. The scheduling may be based on the physical resources in frequency domain (i.e. physical resource blocks) in uplink and/or downlink predefined by the macro base station 1802.
   The common cell identity determines all hybrid femto cells within the cluster 1803. Further, the common cell identity is used for descrambling of data to be received in uplink on PUSCH and for scrambling of data to be transmitted in downlink on PDSCH.
   A timer value T_{HO} for determining the minimum duration of the dedicated communication connection between the mobile terminal 1801 and the cluster of hybrid femto cells 1803. The timer value is for example set by the base station 1802 to, e.g., 10 seconds.

In 1807, the following parameters are sent from the base station 1802 to the mobile terminal 1801 by means of an RRC handover command message 1808:
A cell-specific physical layer cell identity to be used by the mobile terminal 1801 to synchronize to the serving low power node within the cluster of hybrid femto cells 1803. It is assumed that all hybrid femto cells within the cluster 1803 have the same frame and slot timing
A common physical layer cell identity to be used by the mobile terminal 1801 for scrambling of data to be transmitted in uplink on PUSCH and descrambling of data to be received in downlink on PDSCH, respectively.

In 1809, after handover, uplink and/or downlink transmissions on PUSCH/PDSCH take place between the mobile terminal 1801 and the cluster of hybrid femto cells 1803 as follows:
PDSCH transmissions in downlink to the mobile terminal 1801 are only performed by the serving low power node.
The data received in uplink on PUSCH is decoded by all hybrid femto low power nodes within the cluster 1803, and forwarded to the mobile communication network (e.g. a core network of the mobile communication network) if correctly received. In the mobile communication network all correctly received data are collected and duplicate data are discarded.
The timer T_{HO} is initially started at start of transmissions between the mobile terminal 1801 and the cluster of hybrid femto cells 1803 in uplink and/or downlink on PUSCH and PDSCH, respectively.

It is assumed that in 1810, the timer expires without availability of new timer value, i.e. the timer reaches a pre-determined value or a pre-determined time has elapsed without update from the base station 1802. Therefore, the dedicated communication connection of the mobile terminal 1801 will be transferred back to the macro base station 1802.

In 1811, the serving low power node within the cluster of hybrid femto nodes 1803 sends to the base station 1802 a second handover indication message 1812 via the S1 interface.

In 1813, the serving node within the cluster of hybrid femto nodes 1803 sends an RRC handover command message 1814 to the mobile terminal 1801.

In 1815, after handover back to the macro base station 1802, uplink and/or downlink transmissions on PUSCH/PDSCH take place between the base station 1802 and the mobile terminal 1801.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A base station of a mobile communication network, wherein the base station operates a first radio cell of the mobile communication network, the base station comprising
a first signaling circuit configured to signal, for a mobile terminal located in the first radio cell having a communication connection with the mobile communication network via the base station, to a first radio device of a plurality of radio devices located in the first radio cell, wherein each radio device operates a second radio cell of the mobile communication network, that the first radio device is to provide a communication connection between the mobile terminal and the mobile communication network and
a second signaling circuit, configured to signal, for the mobile terminal, to at least one second radio device of the plurality of radio devices, that the at least one second radio device is to take into account the allocation of radio resources by the first radio device for the communication connection to be provided for the mobile terminal when allocating radio resources for communication within the second radio cell operated by the at least one second radio device.

2. Base station according to claim 1, wherein the first radio cell is a macro cell.

3. Base station according to claim 1, wherein the radio devices of the plurality of radio devices are base stations characterized by restricted transmission power and providing small coverage area.

4. Base station according to claim 1, wherein the coverage area of the second radio cells lies within the coverage area of the first radio cell.

5. Base station according to claim 1, wherein the first signaling circuit and the second signaling circuit are implemented by a message transmitting circuit of the base station, wherein the message transmitting circuit is configured
to generate a message indicating that the first radio device is to provide a communication connection between the mobile terminal and the mobile communication network and indicating that the at least one second radio device is to take into account the allocation of radio resources by the first radio device for the communication connection to be provided for the mobile terminal when allocating radio resources for communication within the second radio cell operated by the at least one second radio device and
to send the message to the first radio device and the at least one second radio device.

6. Base station according to claim 5, wherein the message comprises at least one of an identification of the first radio device and an identification of the second radio device.

7. Base station according to claim 5, wherein the message comprises at least one of a physical layer cell identity of the first radio device and a physical layer cell identity of the second radio device.

8. Base station according to claim 5, wherein the message comprises an identification of the mobile terminal.

9. Base station according to claim 1, wherein the base station further comprises a determining circuit configured to determine a set of one or more second radio devices of the plurality of radio devices which are to take into account the allocation of radio resources by the first radio device for the communication connection to be provided for the mobile terminal when allocating radio resources for communication within the second radio cells operated by the one or more second radio devices of the determined set of second radio devices.

10. Base station according to claim 9, wherein the determining circuit is configured to determine the set of one or more second radio devices based on a predetermined radio transmission criterion.

11. Base station according to claim 9, wherein the determining circuit is configured to determine the set of one or more second radio devices based on radio transmission quality measurements of radio transmissions in the first radio cell.

12. Base station according to claim 9, wherein the second signaling circuit is configured to signal to the determined set of one or more second radio devices that they are to take into account the allocation of radio resources by the first radio device for the communication connection to be provided for the mobile terminal when allocating radio resources for communication within the second radio cells operated by the set of one or more second radio devices.

13. Base station according to claim 9, wherein the second signaling circuit is configured to signal an identification of the set of one or more second radio devices to the plurality of radio devices.

14. Base station according to claim 13, wherein the identification of the set of the one or more second radio devices is a physical layer cell identity.

15. Base station according to claim 1, wherein the first signaling circuit is configured to signal an indication of the radio resources to be allocated by the first radio device for the communication connection to be provided for the mobile terminal to the first radio device.

16. Base station according to claim 1, wherein the first signaling circuit is configured to signal an indication of the radio resources to be allocated by the first radio device for the communication connection to be provided for the mobile terminal to the at last one second radio device.

17. Base station according to claim 1, wherein the second signaling circuit is configured to signal to the at least one second radio device of the plurality of radio devices, that the at least one second radio device must not allocate radio resources for communication within the second radio cell operated by the at least one second radio device when the radio resources have been allocated by the first radio device for the communication connection.

18. A radio device of a mobile communication network, wherein the radio device is located in a first radio cell of the mobile communication network operated by a base station and wherein the radio device operates a second radio cell of the mobile communication network, the radio device comprising
a receiver configured to receive from the base station, for a mobile terminal located in the first radio cell having a communication connection with the mobile communication network via the base station, a request to provide a communication connection between the mobile terminal and the mobile communication network
a communication circuit configured to provide a communication connection between the mobile terminal and the mobile communication network in response to the request; and
a signaling circuit configured to signal to at least one other radio device located in the first radio cell and operating another radio cell of the mobile communication network the allocation of radio resources by the radio device for the communication connection.

19. A radio device of a mobile communication network, wherein the radio device is located in a first radio cell of the mobile communication network operated by a base station and wherein the radio device operates a second radio cell of the mobile communication network, the radio device comprising
a receiver configured to receive, from the base station, a request to take the allocation of radio resources by another first radio device for a communication connection between the mobile communication network and a mobile terminal provided by the other radio device into account when allocating radio resources for communication within the second radio cell operated by the radio device and configured to receive from the other radio device an indication of the allocation of radio resources by the other radio device for the communication connection an allocation circuit configured to allocate communication resources for the communication within the second radio cell taking into account the allocation of radio resources by the other radio device for the communication connection.

20. A base station of a mobile communication network, wherein the base station operates a first radio cell of the mobile communication network, comprising a handover circuit configured to hand over a communication connection between a mobile terminal located in the first radio cell and the mobile communication network to a radio device operating a second radio cell of the mobile communication network
a timer configured to measure the time since the handover of the communication connection to the radio device;
a detector configured to detect whether the time since the handover of the communication connection to the radio device has reached a predetermined threshold;
a communication circuit configured to take over the communication connection between the mobile terminal and the mobile communication network from the radio device when it has been detected that the time since the handover of the communication connection to the radio device has reached a predetermined threshold.

21. Base station according to claim 20, wherein the base station comprises a determining circuit configured to determine the threshold.

22. Base station according to claim 21, wherein the determining circuit is configured to determine the threshold based on a predetermined radio transmission criterion.

23. A radio device of a mobile communication network located in a first radio cell operated by a base station of the mobile communication network and operating a second cell of the mobile communication network, comprising
a communication circuit configured to take over a communication connection between a mobile terminal located in the first radio cell and the mobile communication network from the base station
a timer configured to measure the time since the taking over of the communication connection to the radio device;
a detector configured to detect whether the time since the taking over of the communication connection to the radio device has reached a predetermined threshold;
a handover circuit to hand over the communication connection between the mobile terminal and the mobile communication network to the base station when it has been detected that the time since the taking over of the communication connection to the radio device has reached a predetermined threshold.

24. Network component of a mobile communication network comprising a plurality of radio devices, each radio device operating a radio cell, the network component comprising a signaling circuit configured to signal to the plurality of radio devices that the radio devices are to communicate with at least one mobile terminal based on a radio cell identification which is equal for all radio cells operated by the radio devices of the plurality of radio devices.

25. Mobile terminal comprising,
a memory storing a first radio cell identification and a second radio cell identification;
a transceiver configured to perform synchronization with a first radio device based on the first radio cell identification and to perform downlink and uplink communication with the first radio device and the second radio device based on the second radio cell identification.
